(19) United States
(12) Patent Application Publication
(10) Pub. No.: US 2005/0186393 A1
(43) Pub. Date: Aug. 25, 2005

(54) Laminate structure suitable for furniture exteriors

(76) Inventor: Richard C. Wilson, Hollywood Beach, FL (US)

Correspondence Address: BRINKS HOFER GILSON & LIONE, P.O. BOX 10395, CHICAGO, IL, 60610, US

(21) Appl. No.: 10/662,152

(22) Filed: Sep. 12, 2003

Related U.S. Application Data
(60) Provisional application No. 60/410,105, filed on Sep. 12, 2002.

(51) Int. Cl. B32B 1/00

(52) U.S. Cl. 428/141

(57) ABSTRACT

A thermoplastic laminate veneer includes three nominal layers (16,18,20), each formed of a selected thermoplastic polymer. A top layer (16) is formed from one or more sheets (20) of a first acrylic material. A second, intermediate layer (18) is formed of one or more PVC sheets (24), at least one of which has a face (26) presenting an image that is at least partially viewable through the top layer. The third, bottom layer (20) is formed of at least two sheets (28) of a second acrylic material, which may be the same as the first acrylic material. The several layers of the veneer are bonded to one another when the top, intermediate, and bottom layers are hot pressed. The bonded interface between the acrylic sheets of the bottom layer reduces telegraphing of substrate surface irregularities and imperfections to the upper surface (22) of a substrate-mounted veneer.

### CROSS-REFERENCE TO RELATED APPLICATION(S)

This application claims the benefit of U.S. Provisional Application No. 60/410,105, filed Sep. 12, 2002, the disclosure of which is hereby expressly incorporated herein by reference.

### FIELD OF THE INVENTION

The invention relates to a thermoplastic-wood laminate veneers, and a method for making such thermoplastic laminate veneers.

### BACKGROUND OF THE INVENTION

Decorative panels, walls, countertops, furniture, and architectural building components that incorporate a real wood veneer remain in great demand. To accommodate the demand for such products that are intended for use relatively less-hospitable service environments, such as the water-laden environment of marine industries, the prior art teaches the use of decorative polymeric veneers applied to wood or medium-density fiberboard (MDF) substrates that simulate the look of real wood. While such polymeric veneers typically perform significantly better in such environments than real wood veneers, a need continues to exist to improve the performance of such veneered products, including the reduction of a “telegraphing” by the veneer of substrate features, including glue lines, dirt, and other substrate surface imperfections.

### BRIEF SUMMARY OF THE INVENTION

In accordance with an aspect of the invention, a thermoplastic laminate veneer includes a top layer including at least one sheet of a first acrylic material, an intermediate “image” layer, and a bottom layer including at least two sheets of a second acrylic material, wherein the several layers are bonded together by hot pressing at a suitable temperature and pressure, for a suitable time. The veneer's bottom layer is thus characterized by at least two sheets of the second acrylic material, with the bonded interface between the at least two sheets of the second acrylic material causing a discontinuity that bridges a surface imperfection of the substrate when the veneer is mounted on the substrate. Thus, the veneer of the invention helps reduce “telegraphing” of substrate surface irregularities and imperfections, thereby improving the aesthetic qualities of the resulting veneered product incorporating the veneer of the invention.

In accordance with an aspect of the invention, the first acrylic material of the top layer may be modified to improve impact resistance, or with additives that enhance the acrylics performance such as UV inhibitors or colorants, pigments, decorative metal flakes, abrasion resistant additives, or other materials that can alter the appearance of the top acrylic layer and/or provide the laminate's upper surface with a desired set of wear characteristics. The acrylic top layer may also includes an abrasion-resistant coating on its uppermost surface.

The intermediate image layer of the laminate is formed of one or more sheets or films of a polyvinyl chloride (PVC) material that, in an exemplary embodiment, is preferably characterized by a relatively-low loading of plasticizers to thereby reduce gas-off during heat-and-pressure lamination. The intermediate image layer may likewise include additives such as UV inheritors that can improve or otherwise alter the performance of the PVC material. The intermediate image layer preferably has a matte finish to prevent bubble formation by trapped gases. In accordance with an aspect of the invention, an image is conveniently printed on one side of at least one intermediate layer sheet/film using an ink that is compatible with achieving a desired adhesion between the laminate's several layers during hot pressing. In an exemplary embodiment, the image layer is printed with a design that simulates the appearance of wood.

In accordance with another feature of the invention, a method of making a substantially-rigid composite laminate veneer includes stacking or “booking” several layers of selected thermoplastic polymers between a designated pair of press plates, and urging the layers together under suitable heat and pressure, for example, by hot pressing between the heated platens of a hot press, at a selected platen temperature, for a period of time sufficient to achieve cross-linking of the polymers of the several contiguous layers and their constituent sheets Other benefits, features, and advantages of the invention will appear from the following description of several exemplary embodiments.

### BRIEF DESCRIPTION OF THE DRAWINGS

FIG. 1 is a sectional view of an exemplary thermoplastic laminate veneer in accordance with the invention;

FIG. 2 is a sectional view of several “books” stacked within a hot press during an exemplary method of making several of the first exemplary veneer; and

FIG. 3 is an enlarged sectional view showing one of the “books” of FIG. 2, as stacked in the hot press.

### DETAILED DESCRIPTION OF THE INVENTION

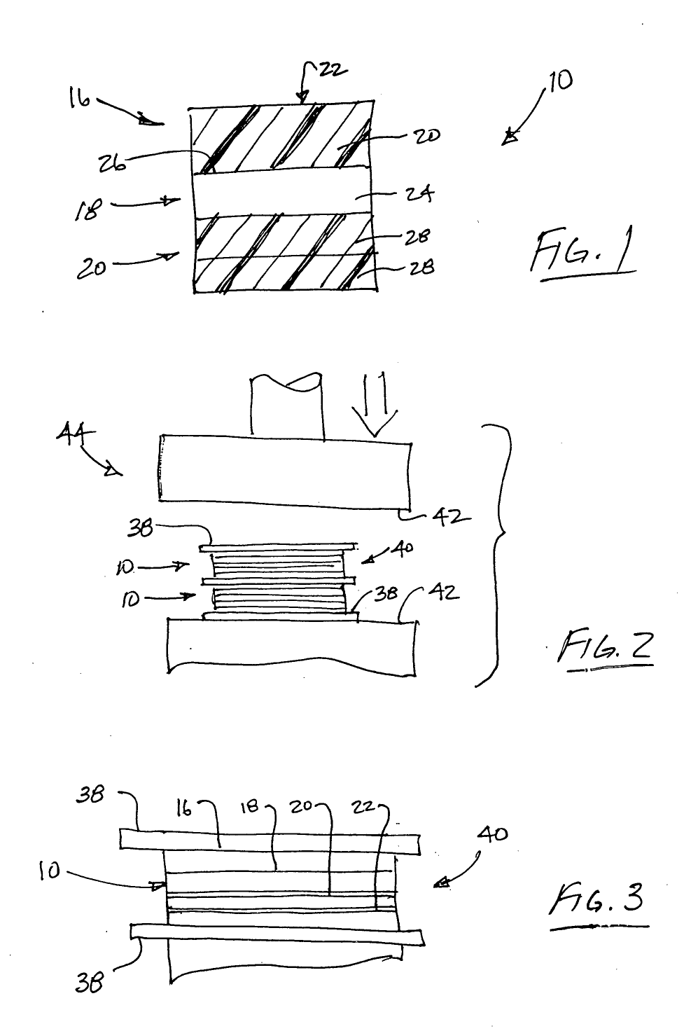

Referring to FIG. 1, an exemplary thermoplastic laminate veneer 10 in accordance with the invention includes three nominal thermoplastic polymer layers, generally referred to herein as the upper or “top layer 16,” the intermediate “image layer 18,” and the bottom layer 20.

As illustrated in FIG. 1, the top layer 16 is formed of one or more sheets 20 of a polymethylmethacrylate (PMMA) material that, depending upon the desired characteristics of the upper surface 22 of the veneer 10, may be a modified acrylic, or impact acrylic. By way of example, in the exemplary laminate veneer 10, the top layer's acrylic material is modified with dibutyl rubber (DR) to thereby improve the layer's impact strength.

While the desired thickness of the veneer 10 necessarily plays a role in selecting appropriate layer thicknesses, the acrylic top layer 16 preferably has a thickness greater than about 0.005 inches, and less than about 0.025 inches. An acrylic top layer thickness of perhaps about 0.015 inches has been demonstrated to provide the resulting veneer 10 with highly-desirable optical characteristics including, for example, enhanced depth or “wetness” of image, as when viewing the veneer's upper surface 22. Such a nominal thickness further ensures that the top layer 16 can be repeatedly polished to restore surface gloss without penetrating the top layer 16. The veneer 10 thus advantageously features a “repairable” upper surface, inasmuch as the nominally glossy surface finish may be restored as by polishing.

The top layer's acrylic material may also be modified, as desired, with additives that enhance other of the layer's performance characteristics, such as UV inhibitors, and/or colorants, pigments, decorative metallic flakes or particles, or other materials that can alter the appearance of the resulting laminate's upper surface 22. An abrasion-resistant coating, for example, a glass hardcoat (not shown), may be applied to the upper surface 22 of the top layer 16, to further improve the wear characteristics, or temperature and/or chemical resistance, of the resulting veneer 10. Similarly, the invention contemplates providing a selected surface finish to the top layer, such as a textured or patterned surface finish, whereby the second intermediate layer's “image” can be similarly modified or enhanced.

The intermediate image layer 18 is likewise formed of one or more sheets or films (hereafter collectively referred to as “sheets 24” for clarity) of a suitable thermoplastic material, such a polyvinyl chloride (PVC) sheet 24. Where the intermediate image layer 18 is formed of more than one PVC sheet, the PVC sheets 24 are simply stacked, one atop another, in the manner described further below and illustrated in FIG. 3. The PVC material of the intermediate image layer 18 can be either rigid or flexible; however, it is preferable to limit the amount of plasticizers used in material compounding prior to extrusion, to thereby reduce gas-off during heat-and-pressure lamination. The intermediate image layer 18 may likewise include additives such as UV inheritors that can improve or otherwise alter the performance of the layer's PVC material. The intermediate image layer 18 preferably has a matte finish to prevent bubble formation by trapped gases.

In accordance with an aspect of the invention, an image is conveniently printed on at least one side 26 of the intermediate image layer 18 using an ink that is compatible with achieving a desired adhesion between the laminate's several layers during hot pressing. By way of example, the intermediate image layer is readily printed with a design to simulate the appearance of wood.

If a pearlescent or metallic effect to the resulting veneer 10 is desired, it is preferably to “compound” the metal into the PVC material itself to thereby obtain an amorphous PVC sheet 24 with no discrete grain boundaries; and metallic loading should be kept at a relatively low level to ensure that such metallic loading does not deleteriously affect the bond strength achieved between the intermediate image layer 18 and either the top or bottom layers 16,20. By way of example only, a suitable pearlescent PVC sheet 24 may include metal flakes or particles, one percent by weight. It is further noted that it is preferable not to put any such metal flakes or particles in the ink itself, or to otherwise layer such metal flakes or particles onto the PVC sheet 24, due to a likely reduction in interlayer bond strength.

The bottom layer 20 of the veneer 10 illustrated in FIG. 1 is formed of at least two acrylic sheets 28, each formed of the same modified PMMA material from which the top layer 16 is formed. Preferably, the at least two acrylic sheets 28 have a substantially-similar nominal thickness, and are stacked, one atop the other, as illustrated in FIG. 1, to obtain the desired bottom layer thickness. The acrylic bottom layer 20 preferably has a thickness ranging from about 0.015 inch to about 0.045 inch, with a thickness of about 0.030 inch being most preferable. The use of multiple plies of a relatively-thinner acrylic sheet 28 reduces “telegraphing” of substrate surface imperfections and irregularities when the veneer 10 is mounted on the substrate.

In order to facilitate bonding and gas-off (as well as to facilitate adhesion of the resulting veneer to a structural substrate), the surfaces of the constituent layers and sheets are preferably provided with a desired surface finish. It will be appreciated, however, that the invention contemplates use, for example, of textured pinch rollers or transfer sheets (not shown) during constituent sheet manufacture/preparation to thereby impart a desired surface finish to the face of a given acrylic or PCV constituent sheet, as necessary, thereby obviating any further surface preparation prior to lay up. Other methods for preparing the sheet surfaces prior to booking are also contemplated, including etching and laser scoring, and/or applying a surface charge to the constituent sheets to thereby cause the laid-up sheets to draw closer to one another.

Referring to FIGS. 2 and 3, in an exemplary method for making a thermoplastic laminate veneer 10, the constituent layers 16,18,20 are stacked between a pair of polished steel press plates 38 to form a “book 40,” whereupon one or more such books 40 are placed/stacked between the platens 42 of a hot press 44. Preferably, when multiple books 40 are stacked between the platens 42 of a given hot press 44, like layer/book thickness should be used to achieve greater yield uniformity.

The stacked books 40 are then hot pressed at a suitable combination of temperatures, preferably ranging from about 240° F. to about 330° F., and pressures, preferably ranging from about 50 psi to about 260 psi (or even as high as about 300 psi for particularly thick books 40, or for large stacks of books 40), to cause the constituent layers and sheets of each book 40 to laminate veneer together, i.e, to achieve a cross-linking of their polymers. The time sequence and overall time of a given book 40 in the hot press 44 is dependent upon how fast the combination of temperatures and pressures can be applied and the overall thickness of the book 40 to be laminated.

In accordance with another aspect of the invention, during hot pressing, the top layer's upper surface 26 may advantageously be imparted with a desired textured or glossy surface finish, depending upon press plate selection. Alternatively, the invention contemplates use of a suitable release sheet (not shown) may be used to provide the desired surface texture and gloss. Still further, the upper press plate 38 used with a given book 40 may itself define a mold so that, during hot pressing, the top layer 16 would assume the design of the mold surface. In this manner, desired surface characteristics and features are readily imparted to the resulting laminate veneer 10,12,14.

Following hot pressing, the laminate veneer 10,12,14 is then cooled to an intermediate temperature that facilitates handling, for example, about 110° F. When this intermediate temperature is achieved, the pressure is released and the laminate veneer removed. Alternately, the laminate veneer 10,12,14 while still hot can be transferred to another press, and a secondary pressure, sufficient to maintain the several constituent layers together, such as 100 psi in the exemplary method, reapplied. The laminate veneer 10,12,14 is then cooled, or permitted to cool, at that second pressure until the temperature of the laminate veneer 10,12,14 falls to the intermediate temperature, at which time the secondary pressure is released.

The resulting laminate veneer 10,12,14 can be bent to conform to a variety of shapes. For relatively-thin laminate veneers, cold bending can be used to achieve gentle bend radii. For sharp bends, the invention contemplates the application of heat prior to bending to thereby achieve a secondary forming temperature of perhaps about 160° F. to about 180° F., using a line bender or other suitable equipment will permit the localized bending of the laminate veneer without delamination of the constituent layers. Preferably, after bending, the bent laminate veneer is annealed, for example, using a blanket or warming room, to reduce spring-back due to memory effect.

The resulting thermoplastic laminate veneers 10,12,14 can be further vacuum thermoformed or pressure thermoformed onto a variety of pre-formed substrates. The thermoplastic laminate veneers 10,12,14 of the invention can also be sawn, routed, drilled, and otherwise machined in order to shape the laminate veneer for the intended use.

Significantly, as illustrated in the sectional views of FIGS. 1-3, the interfaces between the several constituent sheets of a given layer continue to define an interface between these bonded sheets after hot pressing. These interfaces cause discontinuities that advantageously serve to bridge surface imperfections to thereby significantly reduce “telegraphing” of substrate surface imperfections when the resulting laminate veneer is applied as a veneer to a pre-formed substrate.

From the foregoing, it will be appreciated that the thermoplastic laminate veneers of the invention are suitable for a wide variety of applications and uses, including without limitation, as a covering over wood or other material to provide a functional and or decorative cover or stand alone decorative panel or partition, or be installed in a frame. The thermoplastic laminate veneers of the invention can be attached to wood, MDF, or other suitable substrates using a suitable adhesive. The thermoplastic laminate veneers of the invention can also be used in the furniture industry where the flexible laminate veneer will be used to cover and provide a pleasing exterior to cabinet bases, doors, drawers, tables, other articles of furniture.

While the above description discloses several preferred embodiments, it will be appreciated that the invention is susceptible to modification, variation and change without departing from the proper scope and fair meaning of the subjoined claims. For example, while a disclosed exemplary method simultaneously hot presses multiple books at one time, it will be appreciated that the invention contemplates hot pressing one book at a time, for example, on an automated line.

1. A thermoplastic laminate veneer for a pre-formed substrate, the veneer comprising:
a top layer including a sheet of a first acrylic material;
an intermediate image layer formed of one or more sheets of a PVC material, at least one intermediate layer sheet having a face presenting an image; and
a bottom layer formed of at least two sheets of a second acrylic material, wherein the bonded interface between the at least two sheets of the second acrylic material causes a discontinuity that bridges a surface imperfection of the substrate when the veneer is mounted on the substrate.

2. The veneer of claim 1, wherein each of the at least two sheets of the second acrylic material has substantially the same thickness.

3. The veneer of claim 1, wherein one of the first and second acrylic materials is impact modified.

4. The veneer of claim 1, wherein the second acrylic material is substantially identical to the first acrylic material.

5. The veneer of claim 1, wherein the top layer includes one or more selected from the group consisting of colorants, pigments, and decorative metallic flakes.

6. The veneer of claim 1, wherein an upper surface of the top layer includes a textured surface finish.

7. The veneer of claim 1, wherein the first layer further a scratch-resistant coating applied to an upper face of the acrylic sheet.
